(19) United States
(12) Patent Application Publication
(10) Pub. No.: US 2004/0257711 A1
(43) Pub. Date: Dec. 23, 2004

(54) Composite magnetic thin film head

(75) Inventors: Masahiro Ushiyama, Kokubunji (JP); Ichiro Oodake, Odawara (JP); Katsuro Watanabe, Kanasago (JP); Taku Shintani, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Global Storage Technologies, Japan , Ltd., Kanagawa-ken (JP)

(21) Appl. No.: 10/871,154

(22) Filed: Jun. 18, 2004

(30) Foreign Application Priority Data
Jun. 18, 2003 (JP) 2003-172771

(51) Int. Cl. G11B 5/33

(52) U.S. Cl. 360/317

(57) ABSTRACT

The influence of ion milling is extremely suppressed even in a composite magnetic thin film head comprising a magnetoresistive thin film head used by passing an electric current perpendicularly to a multilayer structure. The number of ion milling steps after the formation of a magnetoresistive thin film head is reduced as much as possible, whereby the influence of electrostatic charging arising from an ion milling apparatus is obviated. In specific embodiments, an inductive magnetic thin film head is first formed on a substrate, and thereafter a magnetoresistive thin film head is formed thereon. The magneto resistive thin film head includes a magneto resistive film having a multilayer structure and configured to be used by passing a detection current perpendicularly to the multilayer structure. In one embodiment, the inductive magnetic thin film head has a structure in which a coil is buried at the same horizontal position as a lower pole.

### CROSS-REFERENCES TO RELATED APPLICATIONS

This application claims priority from Japanese Patent Application No. 2003-172771, filed Jun. 18, 2003.

### BACKGROUND OF THE INVENTION

The present invention relates to a composite magnetic thin film head comprising a magnetoresistive thin film head used by passing a detection current perpendicularly to a multilayer structure.

Attendant on the expansion of information technology (IT) for personal use, the volume of information that can be recorded has markedly increased; still there has been an increasing demand for a recording apparatus such as a hard disk drive which has a larger capacity. In order to inexpensively realize a larger capacity, the recording capacity per unit area must be increased. In other words, it is necessary to reduce the recording area by one bit. The reduction of the recording area leads to a lowering in the intensity of a magnetic signal, and, therefore, a larger capacity cannot be attained without an improvement of the sensitivity of the recording head.

With the aim of enhancing sensitivity, research and development of a magnetoresistive film for a magnetoresistive thin film head having a reproduction function have been conducted. In hard disk drives, which are the main stream in the market at present, giant magnetoresistive films (GMR films) are used, but they are considered to be reaching their limit in the near future. In recent years, therefore, research has turned to tunneling magnetoresistive film (TMR film) and to a giant magnetoresistive film that pass a detection current perpendicularly to the multilayer structure (Current Perpendicular to the Plane giant magnetoresistive film, CPP-GMR film), and the like.

TMR film and CPP-GMR film differ from the conventional CIP-type (Current In the Plane) magnetoresistive film in that the current is passed perpendicularly to the multilayer film.

In a magnetoresistive thin film head comprising a CIP-type magnetoresistive film, the magnetoresistive film is electrically insulated from a lower shield film and an upper shield film by an insulating film. Referring to the drawings, as shown in FIG. 1 (air-bearing surface), a magnetoresistive thin film head has a structure in which an undercoat film 2 formed of alumina, a lower shield film 3, a lower insulating film 4 formed of alumina, a giant magnetoresistive film 5, a seed film 6 for a magnetic-domain-control film, the magnetic-domain-control film 7, an electrode film 8, an upper insulating film 9, and an upper-shield film 10 are sequentially provided on an AlTiC substrate 1.

In contrast, in the cases of the TMR- and CPP-types of magnetoresistive films, the magnetoresistive film is electrically connected to the lower shield film and the upper shield film. Specifically, as shown in FIG. 2 (air-bearing surface), the magnetoresistive thin film head has a structure in which an undercoat film 22 formed of alumina, a lower shield film 23, a TMR film 27, and an upper shield film 33 are sequentially provided on an AlTiC substrate 21. The other layers include an insulating layer 28, a longitudinal bias impressing layer 29, a second insulating layer 30, and a Ru film 31.

In a composite magnetic thin film head constituting a conventional hard disk drive, a magnetoresistive thin film head is provided on a substrate, and then an inductive magnetic thin film head is provided. Specifically, as shown in FIG. 3, after formation of the magnetoresistive thin film head described in FIG. 1 above, an insulating film 49, a first layer lower pole 50, a second layer lower pole 51, an insulating film 52, and a first layer upper pole 53 are formed. Thereafter the first layer upper pole 53, the insulating film 52 and the second layer lower pole 51 are shaped into a required structure by ion milling, and then an induction coil and a second layer upper pole are formed. The layers of the magnetoresistive thin film head on the AlTiC substrate 41 and undercoat film 42 include lower shield film 43, lower insulating film 44, giant magneto resistive film 45, domain control film and electrode film 46, upper insulating film 47, and upper shield film 48.

When the process of fabricating the composite magnetic thin film head comprising an inductive magnetic thin film head on a magnetoresistive thin film head is reviewed from the viewpoint of ion milling treatment after formation of a magnetoresistive film, the treatment is conducted in a seed film removing step before formation of a plating film. The components relating to this treatment include an upper shield 48, the first layer lower pole 50, the second layer lower pole 51, the first layer upper pole 53, the inductive coil, and an Au pad.

In particular, the ion milling treatment is frequently conducted in the process of forming the inductive magnetic thin film head. When a solid plating method is conducted and thereafter patterning is conducted to remove the plating film, the time required for ion milling is very long. In an ion milling apparatus applied to production in such a process, an electrically neutralizing function is held, and, when the apparatus is in normal operation, the electrostatic charging of a wafer due to the ion milling is generally restrained to be slight.

However, when the apparatus condition deviates from a normal condition due to some trouble in mass production, the wafer under treatment may be electrostatically charged. In this case, in the composite magnetic thin film head (FIG. 3) comprising a conventional giant magnetoresistive film, giant magnetoresistive film 45 is electrically insulated from lower shield film 43 and upper shield film 48 by insulating films 44 and 47. Therefore, giant magnetoresistive film 45 is less likely influenced by such a misoperation of the ion milling apparatus. In addition, when, as shown in FIG. 4, upper shield film 65 and lower shield film 63 are electrically connected directly to each other (portion 66 of FIG. 4) during the wafer process, even if upper shield film 65 is electrostatically charged, the electric charge flows into lower shield film 63, so that there is little possibility that the electric charge might flow to the giant magnetoresistive film 64. In this case, when at least one of the two terminals of the magnetoresistive thin film head is electrically insulated from the shields, no trouble arises regarding the evaluation of characteristics of the magnetoresistive thin film head. These layers are disposed on the AlTiC substrate 61 and undercoat film 62.

On the other hand, in the cases of TMR and CPP magnetoresistive films, lower shield film 23 and upper shield film 33 are electrically connected by magnetoresistive film 27 as shown in FIG. 2. Therefore, when upper shield film 33 is electrostatically charged, the electric charge flows to magneto resistive film 27 with ease. In this case, when the shields are electrically connected to each other at a location other than the head element as mentioned above, they are connected in parallel with the device, making it difficult to evaluate the TMR characteristics or CPP-GMR characteristics.

### BRIEF SUMMARY OF THE INVENTION

Embodiments of the present invention overcome the above problems and provide an inductive magnetic thin film head and a magnetoresistive thin film head that are sequentially provided on a substrate. In a composite magnetic thin film head to which the present structure is applied, the lengthy ion milling treatment after the formation of a magnetoresistive film is conducted only at the times an upper shield and an Au pad are formed. This ensures that the influence of ion milling is extremely suppressed even in a composite magnetic thin film head comprising a magnetoresistive thin film head used by passing an electric current perpendicularly to a multilayer structure.

The structure in which the inductive magnetic thin film head and the magneto resistive thin film head are sequentially provided on the substrate and which is one important feature of the present invention is described as an inverse-type composite magnetic thin film head in Japanese Patent Laid-open No. 2000-57534. In that patent, the deterioration of reproduction sensitivity of an MR head due to heat treatment in the formation of the head is taken as a problem, and no reference is made to the influence of ion milling in a composite magnetic thin film head comprising a magnetoresistive thin film head used by passing an electric current perpendicularly to a multilayer structure as shown in embodiments of the present invention.

In specific embodiments of the present invention, the magnetoresistive thin film head is formed on the inductive magnetic thin film head. Therefore the formation of a track in the magnetoresistive thin film head is particularly liable to be influenced by the structure therebeneath. The track is generally formed by exposure of a resist. A problem may arise that the track cannot be stably formed because the light or electrons used for the exposure are reflected by the structure beneath the resist after passing through the resist. However, if the final surface of the inductive magnetic thin film head is flat, the track structure of the magnetoresistive thin film head formed thereon can be stabilized. As shown in FIG. 5, the desired track structure can be realized by the structure in which the final surface of the inductive magnetic thin film head (surface of upper pole 80) is flat. This structure can be formed by providing a structure in which a coil 74 of the inductive magnetic thin film head is buried at the same horizontal position as a lower pole 72, and subjecting the surface of upper pole 80 to chemical mechanical polishing (CMP).

Furthermore, where a conventional structure is used for the inductive magnetic thin film head, the upper side of the coil is covered with the second layer upper pole as shown in FIG. 4, resulting in that the distance between the gap of the inductive magnetic thin film head and the surface of the second layer upper pole is large, not less than 5 μm on standard. This leads to an increase in the read/write gap distance, thereby deteriorating the formatting efficiency of the hard disk drive. On the other hand, in the inductive magnetic thin film head in which the coil is buried at the same horizontal position as the lower pole (FIG. 5), only the upper pole 80 is present on the upper side of the gap 79 of the inductive magnetic thin film head, so that the read/write gap distance can be reduced. In other words, in order to realize a hard disk drive with excellent formatting efficiency using the composite magnetic thin film head in which an inductive magnetic thin film head and a magnetoresistive thin film head are sequentially provided on a substrate, it is essential to establish a process of producing an inductive magnetic thin film head in which the surface of an upper pole or electrode 80 is flat.

In addition, in the inductive magnetic thin film head having such a structure, a sufficient overwrite characteristic cannot necessarily be attained. Reducing the track width for enlarging the capacity of a hard disk drive causes deterioration of the overwrite characteristic. In order to obviate this problem, it is necessary to enhance the saturation magnetic flux density of the poles on both sides of the write gap and to lower the resistance of the coil. According to embodiments of the present invention, in order to solve this problem, a magnetic thin film head is provided in which the saturation magnetic flux density of the pole adjacent to the write gap (at least one of the upper pole and the lower pole) is not less than 2.3 teslas and the ratio of the coil width to the space between the coils is not less than 3.

While the foregoing has been described with reference to a case where the inductive magnetic thin film head is of the longitudinal recording system, it can also be applied to the perpendicular recording system. Specifically, when the inductive magnetic thin film head is of the perpendicular recording system, the desired magnetic thin film head can be realized by flattening the surface of a main pole and providing a magnetoresistive thin film head on the flattened main pole.

While the present invention is effective for a composite magnetic thin film head comprising a magnetoresistive thin film head used by passing an electric current perpendicularly to a multilayer structure, it is possible to adopt a TMR film or a CPP-GMR film as the magnetoresistive film.

According to embodiments of the present invention, the influence of ion milling after formation of a magnetoresistive thin film head can be improved. If deterioration of the magnetoresistive thin film head due to ion milling should be generated, whether the device is nondefective or rejectable could be determined through evaluation of characteristics immediately before completion of the wafer, and, therefore, a rejectable device would not be shipped.

### BRIEF DESCRIPTION OF THE DRAWINGS

FIG. 1 is a schematic diagram of an air-bearing surface of a magnetoresistive thin film head comprising a CIP-type GMR film.

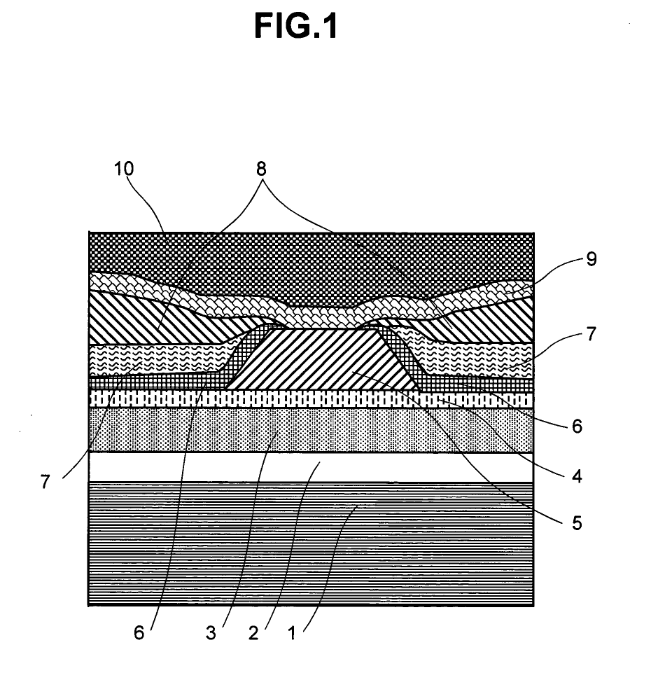

FIG. 2 is a schematic diagram of an air-bearing surface of a magnetoresistive thin film head comprising a CPP-type GMR film.

FIG. 3 is a schematic diagram of an air-bearing surface of a composite magnetic thin film head comprising a CIP-type GMR film.

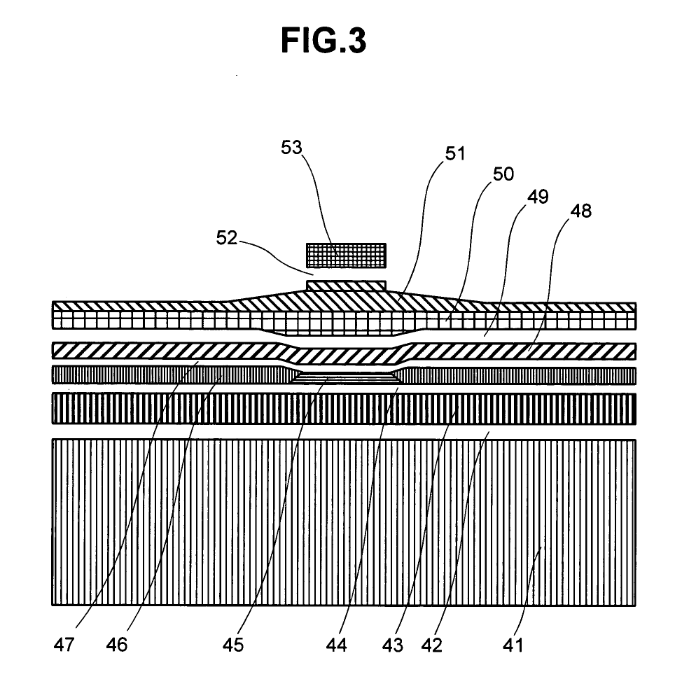

FIG. 4 is a schematic diagram of a section of a composite magnetic thin film head, showing electrical connection between an upper shield and a lower shield in the process of forming a magnetoresistive thin film head comprising a CIP-type GMR film.

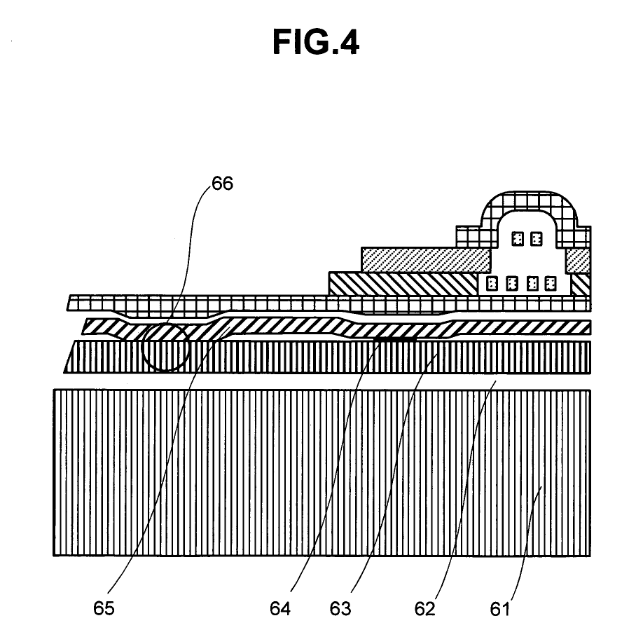

FIG. 5 is a schematic diagram of a section of an inductive magnetic thin film head having a structure in which a coil is buried at the same horizontal position as a lower pole in accordance with an embodiment of the present invention.

FIG. 6 is a schematic diagram of an air-bearing surface of a composite magnetic thin film head in which an inductive magnetic thin film head and a magnetoresistive thin film head are sequentially provided on a substrate.

FIG. 7 is a schematic diagram of a section of a composite magnetic thin film head in which an inductive magnetic thin film head is of the perpendicular recording system in accordance with another embodiment of the present invention.

### DETAILED DESCRIPTION OF THE INVENTION

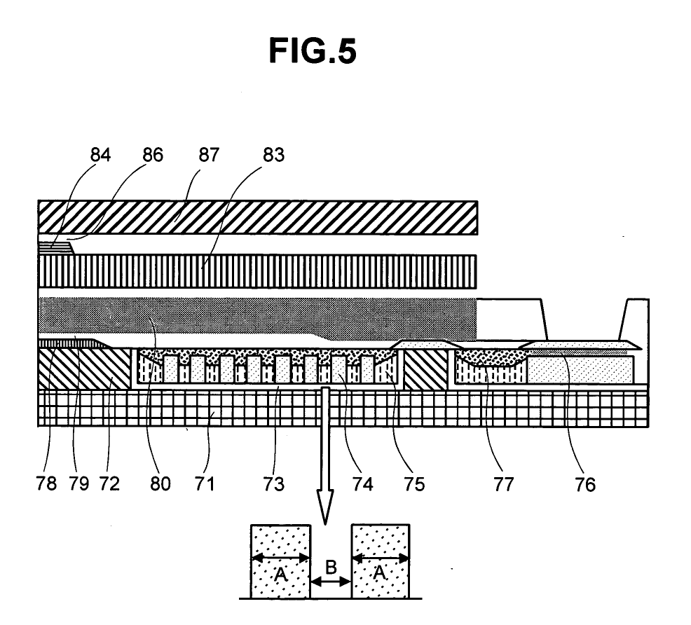

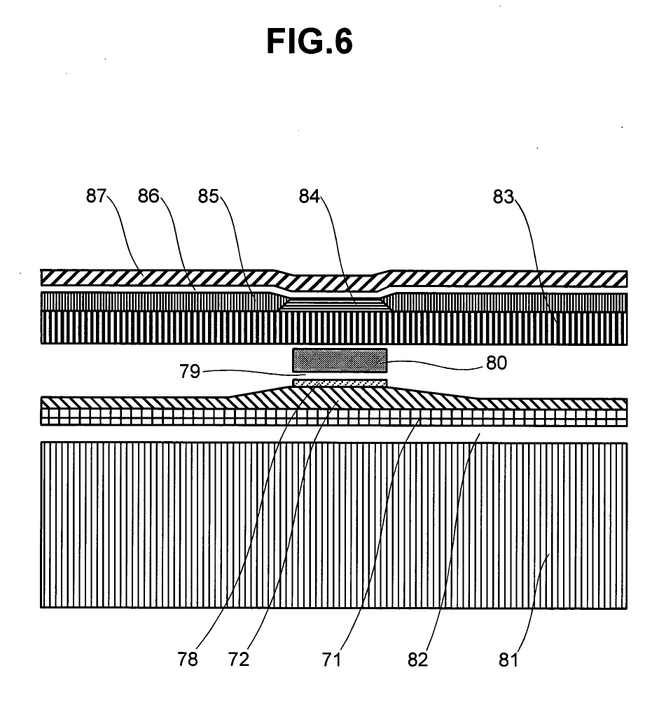

Some embodiments of the present invention are described below with reference to the drawings. FIG. 5 illustrates a section of a composite magnetic thin film head according to a first embodiment of the present invention, and FIG. 6 illustrates an air-bearing surface of the composite magnetic thin film head. The composite magnetic thin film head is completed by forming an undercoat 82 on an AlTiC substrate 81, and then sequentially providing thereon an inductive magnetic thin film head and a magnetoresistive thin film head used by passing an electric current perpendicularly to a multilayer structure.

The inductive magnetic thin film head is formed as follows. A first layer lower pole 71 is formed by a pattern-plating method; a seed film for plating is removed; an alumina film is formed by sputtering; and the surface of the first layer lower pole 71 is exposed while flattening the surface by CMP. Then, a second layer lower pole 72 is formed on the surface of the first layer lower pole 71 by a pattern-plating method.

Next, an alumina film 73 is formed; thereafter a coil 74 is formed; and a pattern 76 for electrical connection to a coil contact portion is formed. Conventionally, a resist pattern has been formed after formation of the alumina film 73, and the coil 74 has been formed in the gap thereof by plating. In this embodiment, after formation of the resist pattern, the resist was slimmed by ashing to broaden the gap, and then the coil 74 was formed by plating. By this method, it is possible to obtain a structure having a coil width A of about 1.3 μm, a coil space B of about 0.3 μm, and a ratio (A/B) of coil width to space width of about 4.33, as contrasted to the conventional design having a coil width A of 1.0 μm, a coil space B of 0.6 μm, and a ratio (A/B) of coil width to space width of 1.67. In this embodiment, an effect of preventing overwrite characteristics from being lowered was displayed when a ratio (A/B) of coil width to space width was not less than 3. Here, the coil width A means the line width of the coil on the side close to the air-bearing surface of the magnetic thin film head as shown in FIG. 5, and the space width B means the width of the space between the coils.

Subsequently, a resist film for insulation between the coils is applied, followed by annealing to fill up the spaces between the coils with the resist film 75. Next, the coil surface is exposed by reactive ion etching using oxygen, and alumina 77 is formed by sputtering in such a film thickness that the film thickness on the coil will be higher than the upper surface of the second layer lower pole 72. Then, the surface of the second layer lower pole 72 is exposed while keeping the surface flat by CMP. Subsequently, a high-Bs film for constituting a third layer lower pole 78 is formed by sputtering, and is processed into a desired shape.

Next, an SiO₂ film to be used for a write gap 79 is built up by sputtering, and is processed into a desired shape. A high-Bs film as a seed film for an upper pole 80 is formed; then a narrow write track pattern is formed by use of KrF excimer laser; and the upper pole 80 is formed by plating. Subsequently, alumina is built up until the upper pole 80 is buried, and the surface of the upper pole 80 is exposed while keeping the surface flat by CMP. Here, as the seed film for the upper pole 80 and the film subsequently formed by plating, a magnetic film which contains Fe, Co, and Ni as main constituents and which has a saturation magnetic flux density of about 2.35 teslas was used. A plating film having such a high-saturation magnetic flux density could be realized, without corrosion, by controlling the electric current in immersing the wafer in a plating solution.

In this embodiment, at least one film of the third layer lower pole 78 and the upper pole 80, which are poles adjacent to the write gap 79, was made to have a saturation magnetic flux density of not less than about 2.3 teslas, whereby an effect of preventing overwrite characteristics from being lowered was displayed. In this manner, the inductive magnetic thin film head having a flat surface could be fabricated, in which the coil 74 is buried at the same horizontal position as the lower pole 72.

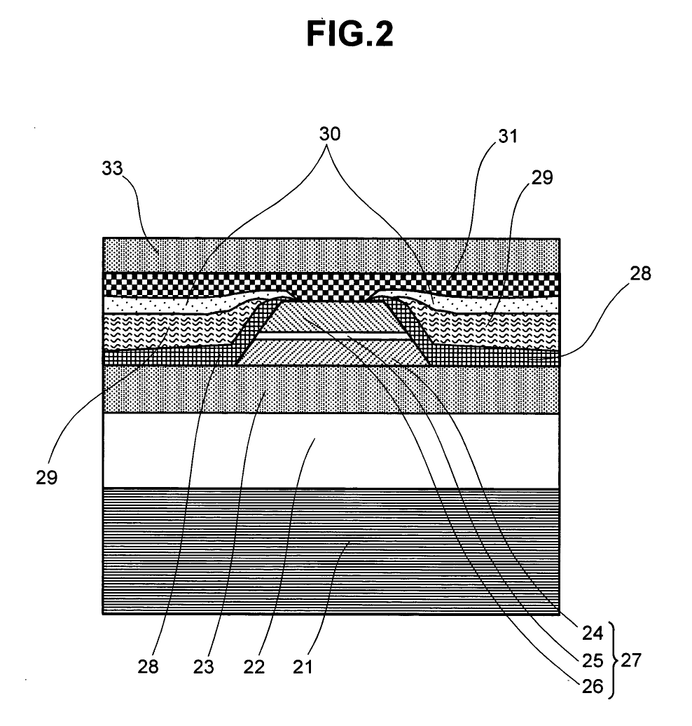

Subsequently, the magnetoresistive thin film head is formed. An insulating film consisting of alumina is formed on the upper pole of the inductive magnetic thin film head, and a lower shield 83 (23 in FIG. 2; hereinafter, the parenthesized symbols denote the portions in FIG. 2) is formed thereon. Subsequently, an alumina film is built up until the lower shield 83 (23) is buried, and the surface of the lower shield 83 (23) is exposed while keeping the surface flat by CMP. Next, an electrode film consisting of Ta/Au/Ta for constituting a lead wire is formed at a position away from the head element. A TMR film 84 (27) is formed on the lower shield 83 (23) by sputtering. The TRM film 84 (27) consists of a pinned layer (24) composed of a layer containing a CoFe based alloy as a ferromagnetic material, an intermediate layer (25) consisting of an alumina film, and a free layer (26) composed of a layer containing an NiFe-based alloy and a CoFe-based alloy. Subsequently, the TMR film 84 (27) is processed into a desired shape by a lift-off process using a two-layer resist and an ion beam deposition method.

Thereafter, an insulating layer (28) formed of alumina, a longitudinal bias impressing layer (29) consisting of a CoCrPt film, and a second insulating layer (30) formed of alumina are sequentially formed by sputtering. On these layers, Ru film 86 (31) is formed by sputtering. An upper shield film 87 (33) is formed on the whole wafer surface by sputtering, and the upper shield 87 (33) is processed into a desired shape by ion milling with a resist as a mask. With the upper shield 87 (33) thus formed, the magnetoresistive thin film head is completed.

Subsequently, Cu terminals are formed; an overcoat alumina film is formed; and Au pads are formed to complete the composite magnetic thin film head.

Although the upper shield film 87 (33) is formed by sputtering in the above embodiment, it may be formed by plating. Where plating is used, there is a “solid plating method” for forming a film on the whole wafer surface or a “pattern plating method” for conducting plating after a resist is formed in a desired shape. When the pattern plating method is used, it suffices to remove only the seed film for plating by ion milling so that the time required for ion milling is shortened, and the influences at the time of electrostatic charging of the wafer due to an abnormal condition in the ion milling apparatus can be restrained. Accordingly, in the composite magnetic thin film head comprising the magnetoresistive thin film head used by passing an electric current perpendicularly to the multilayer structure, it is preferable to form the upper shield 87 (33) by the pattern plating method.

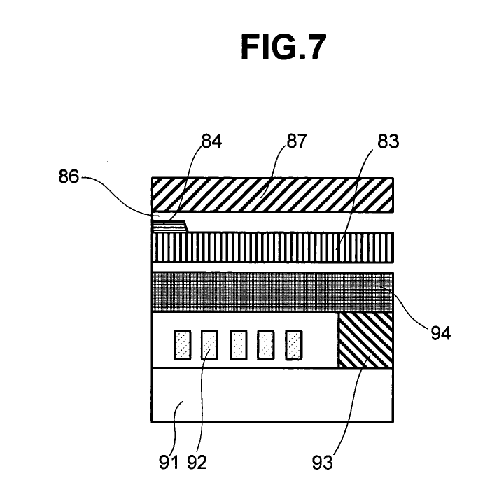

FIG. 7 illustrates a case where the present invention is applied to a magnetic head of a perpendicular recording system, as another embodiment of the present invention. As shown in the cross-sectional view of FIG. 7, after formation of an auxiliary pole 91, a coil 92 is formed; an alumina film is built up thereon; a hole is bored in the alumina film; and a metallic film 93 for connection between the auxiliary pole 91 and a main pole 94 is formed. Subsequently, the surfaces of the alumina film and the metallic film 93 are flattened by CMP, and main pole 94 is formed to produce an inductive magnetic thin film head of the perpendicular recording system. Thereafter, the magnetoresistive thin film head (83, 84, 86, 87) is formed in the same manner as above to complete the composite magnetic thin film head. If required, the surface of main pole 94 may be flattened by CMP after being formed. Thus, even in the case of the inductive magnetic thin film head of the perpendicular recording system, formation of a track in the inductive magnetic head can be stably conducted because the surface of the main pole 94 is flat.

According to embodiments of the present invention, even in a composite magnetic thin film head comprising a magnetoresistive thin film head used by passing an electric current perpendicularly to a multilayer structure, deterioration of the magnetoresistive effect due to ion milling during the wafer process can be restrained, and a good yield on the wafer process can be secured. Even if the magnetoresistive effect is deteriorated due to the ion milling, rejectable devices can be determined through measurement of magnetic characteristics in the final step of the wafer process, so that rejectable devices will not be shipped. When a structure in which the surface of an upper pole is flat is adopted as the structure of an inductive magnetic thin film head, a hard disk drive with an excellent formatting efficiency can be manufactured even when a composite magnetic thin film head in which an inductive magnetic thin film head and a magnetoresistive thin film head are sequentially formed on a substrate.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A composite magnetic thin film head comprising:
a substrate;
an inductive magnetic thin film head; and
a magneto resistive thin film head,
wherein said magneto resistive thin film head includes a magneto resistive film having a multilayer structure and configured to be used by passing a detection current perpendicularly to the multilayer structure, and
wherein said inductive magnetic thin film head and said magneto resistive thin film head are sequentially provided on said substrate.

2. A composite magnetic thin film head as set forth in claim 1, wherein said inductive magnetic thin film head comprises an upper pole having a surface which is flat.

3. A composite magnetic thin film head as set forth in claim 1, wherein said inductive magnetic thin film head comprises a lower pole and a coil, and wherein the coil is buried at a same horizontal position as the lower pole.

4. A composite magnetic thin film head as set forth in claim 1, wherein said inductive magnetic thin film head comprises an upper pole and a lower pole, and wherein a saturation magnetic flux density of a portion, adjacent to a write gap, of at least one of the upper pole and the lower pole of said inductive magnetic thin film head is not less than about 2.3 teslas.

5. A composite magnetic thin film head as set forth in claim 1, wherein said inductive magnetic thin film had comprises a plurality of coils, and wherein a ratio of a line width of the coils in the vicinity of an air bearing surface of said inductive magnetic thin film head to a space between said coils is not less than about 3.

6. A composite magnetic thin film head as set forth in claim 1, wherein said inductive magnetic thin film head is of a perpendicular recording system.

7. A composite magnetic thin film head as set forth in claim 6, wherein a surface of a main pole of said inductive magnetic thin film head is flat.

8. A composite magnetic thin film head as set forth in claim 1, wherein said multilayer structure comprises a tunneling magneto resistive film.

9. A composite magnetic thin film head as set forth in claim 1, wherein said multilayer structure comprises a giant magneto resistive film for passing a detection current perpendicularly to said multilayer structure.

10. A composite magnetic thin film head as set forth in claim 1, wherein an upper shield film of said magneto resistive thin film head is a magnetic film formed by a pattern plating method.

11. A composite magnetic thin film head as set forth in claim 1, wherein said magneto resistive thin film head comprises a lower shield film, a TMR film, a Ru film, and an upper shield film.

12. A composite magnetic thin film head comprising:
a substrate;
an inductive magnetic thin film head disposed on said substrate; and
a magneto resistive thin film head disposed on said inductive magnetic thin film head,
wherein said inductive magnetic thin film head comprises a lower pole, a plurality of coils disposed above a portion of the lower pole, a resist film disposed between the coils, a pattern for electrical connection to a coil contact portion for the coils, a write gap above the lower pole, and an upper pole above the write gap.

13. A composite magnetic thin film head as set forth in claim 12,
wherein said lower pole of said inductive magnetic thin film head comprises a first layer lower pole, a second layer lower pole on a portion of the first layer lower pole, and a third layer lower pole on the second layer lower pole,
wherein said inductive magnetic thin film head comprises an alumina film on another portion of the first layer lower pole, and
wherein the plurality of coils and the resist film are disposed on the alumina film.

14. A composite magnetic thin film head as set forth in claim 12, wherein a saturation magnetic flux density of a portion, adjacent to the write gap, of at least one of the upper pole and the lower pole of said inductive magnetic thin film head is not less than about 2.3 teslas.

15. A composite magnetic thin film head as set forth in claim 12, wherein a ratio of a line width of the coils in the vicinity of an air bearing surface of said inductive magnetic thin film head to a space between said coils is not less than about 3.

16. A composite magnetic thin film head comprising:
a substrate;
an inductive magnetic thin film head disposed on said substrate; and
a magneto resistive thin film head disposed on said inductive magnetic thin film head,
wherein said magneto resistive thin film head includes a multilayer structure and is configured to pass a detection current perpendicularly to the multilayer structure, and
wherein said inductive magnetic thin film head comprises an auxiliary pole, a metallic film on the auxiliary pole, and a main pole on the metallic film.

17. A composite magnetic thin film head as set forth in claim 16, wherein said inductive magnetic thin film head comprises a plurality of coils disposed between the auxiliary pole and the main pole.

18. A composite magnetic thin film head as set forth in claim 16, wherein a surface of the main pole of said inductive magnetic thin film head is flat.

19. A composite magnetic thin film head as set forth in claim 16, wherein said multilayer structure comprises a tunneling magneto resistive film.

20. A composite magnetic thin film head as set forth in claim 16, wherein said multilayer structure comprises a giant magneto resistive film for passing a detection current perpendicularly to said multilayer structure.
